(19) United States
(12) Patent Application Publication
(10) Pub. No.: US 2015/0147604 A1
(43) Pub. Date: May 28, 2015

(54) METHOD FOR REDUCING THE DENDRITIC METAL DEPOSITION ON AN ELECTRODE AND LITHIUM-ION RECHARGEABLE BATTERY WHICH USES THIS METHOD

(71) Applicant: Robert Bosch GmbH, Stuttgart (DE)

(72) Inventor: Niluefer BABA, Stuttgart (DE)

(21) Appl. No.: 14/553,635

(22) Filed: Nov. 25, 2014

(30) Foreign Application Priority Data
Nov. 27, 2013 (DE) 10 2013 224 251.4

(51) Int. Cl. H01M 10/42; H01M 10/48

(52) U.S. Cl. CPC H01M 10/4257; H01M 10/48
USPC 429/50; 429/61

(57) ABSTRACT

In a method for reducing the dendritic metal deposition on an electrode, a non-dendritic state of the metal deposition is ascertained, and a magnetic or electric field is generated at the electrode and is modulated in such a way that it stabilizes the non-dendritic state of the metal deposition. The method is applied, e.g., to a lithium-ion rechargeable battery including an anode having an anode arrester, a cathode having a cathode arrester, and a separator, which are situated in a housing, in which a dendritic metal deposition at the anode is reduced with the aid of the method.

### BACKGROUND OF THE INVENTION

1. Field of the Invention

The present invention relates to a method for reducing the dendritic metal deposition on an electrode, and also relates to a lithium-ion rechargeable battery and a method for manufacturing a lithium-ion rechargeable battery.

2. Description of the Related Art

Novel lithium rechargeable battery concepts, for example, lithium-sulfur or lithium-air batteries, promise significantly higher energy densities as opposed to classic oxide lithium-ion rechargeable batteries. These new rechargeable battery concepts are the subject of intense research. One problem in this regard is the dendritic growth of the lithium anode during battery operation. This dendritic growth limits significantly the cyclical service life of the lithium-ion rechargeable battery and, in addition, represents a significant safety risk. Dendrites are able to perforate the separator and result in local short circuits. These local short circuits may involve a thermal burnout of the rechargeable battery. The thermal burnout may culminate in a battery fire or in a battery explosion.

The research works “Applications of magnetoelectrolysis,” R. S. Tacken, L. J. J. Janssen, Journal of Applied Electrochemistry 25 (1995), 1-5; “Influence of a magnetic field on the electrodeposition of Nickel and Nickel-Ion Alloys,” A. Ispas, A. Bund, The 15th Riga and 6th Pamir Conference of Fundamental and Applied MHD; “The effect of a magnetic field on the morphologies of nickel and copper deposits: the concept of ‘effective overpotential’” N. D. Nikloic, J. Serb. Chem. Soc. 72(8-9) 787-797 (2007), were able to show the inhibiting effect of a magnetic field on the electrochemical dendritic metal deposition.

In U.S. Pat. No. 5,728,482, the use of a magnetic field for suppressing dendritic lithium growth in a secondary lithium battery is described. For this purpose, the magnetic field is set perpendicularly to the electric field of the rechargeable battery electrodes and regulated with respect to the degree of its field strength.

### BRIEF SUMMARY OF THE INVENTION

The method according to the present invention for reducing the dendritic metal deposition on an electrode includes ascertaining a non-dendritic state of metal deposition at the electrode, and generating a magnetic or electric field, preferably a magnetic field, which is modulated in such a way that it stabilizes the non-dendritic state of metal deposition. In this way, the method according to the present invention makes it possible to generate a customized magnetic field, which specifically suppresses the formation of dendrites, in particular of lithium, on an electrode. The method is suitable, in particular, for inhibiting dendritic growth on electrodes of rechargeable batteries. In principle, however, it may be used to inhibit or suppress dendritic growth of electrochemically deposited, mostly metal, layers in other fields of application as well.

The method according to the present invention has multiple advantages, in particular, when used to reduce dendritic metal deposition in a lithium-ion rechargeable battery. The present invention makes it possible to identify and to adjust a non-dendritic electrochemical deposition state suitable to the application. The non-dendritic electrochemical deposition state may be adjusted with the aid of suitably small magnetic or electric forces. High magnetic or electric field strengths, as they have been used or suggested to date in conjunction with metal deposition in an electrochemical system, are unnecessary. By suppressing or inhibiting dendritic lithium metal growth, the electrolyte consumption of a lithium-ion rechargeable battery as a result of continuous SEI formation (SEI: solid electrolyte interface), i.e., a “running dry of the battery,” is prevented, which results in a significant prolongation of the cyclical and calendar service life of the lithium battery. Moreover, the short circuit resulting from the perforation of the separator by a hypertrophied dendrite is avoided and the service life is prolonged. There is also no increase in volume as a result of a dendritically grown metal dendrite foam structure, and no damage to the housing of a rechargeable battery due to the volumetrically expanding metal dendrite foam.

The present invention makes the commercial manufacture and use of novel rechargeable lithium metal batteries (for example, lithium-sulfur batteries or lithium-air batteries) and other battery types possible, which previously were not rechargeable due to dendrite formation. As a result, it makes (lithium) batteries possible having a significantly higher energy capacity than, for example, traditional batteries having a graphite anode, in which only ⅙ of the lithium ions may be intercalated, as compared to the novel batteries. The use of pure lithium electrodes results in this case in a lower overall battery weight, since lithium is lighter, for example, than graphite. In this way, a greater gravimetric energy density is achieved. In addition, only narrower or lighter conductors are required, since lithium is electrically conductive.

Many of the advantages enumerated above, which are directed primarily to the lithium-ion rechargeable battery, may also be achieved for other rechargeable batteries, in particular, rechargeable batteries using metal electrodes (for example, zinc-air battery, lead battery, etc.).

In large-scale electrochemical deposition of metals, a homogeneous deposition with no dendrites is desired. This is achieved by the method according to the present invention. A blind (“trial and error”) and, therefore, an elaborate search of the suitable process parameters, is therefore avoided.

The dendritic lithium growth on the anode of a lithium-ion rechargeable battery is a non-linear pattern-formation process. It is therefore preferred that the non-dendritic state of the metal deposition is ascertained by an analysis method of the non-linear pattern formation. Particularly preferably, the analysis method of a non-linear pattern formation includes the following steps:
transitioning a metal deposition on the electrode into a chaotic state,
ascertaining unstable states of metal deposition having a regular dynamic with the aid of an attractor reconstruction from an experimental time series of the system considered, and
selecting a [b1] state from the unstable states as the non-dendritic state.

This involves a non-linear chaos control, i.e., a method for transitioning chaotic behavior of a system into a stable periodic movement through small changes to the system parameters. In this method, the chaotic state corresponds to a coexistence of an infinite number of unstable states having a periodic or regular dynamic. One of these unstable states is the desired non-dendritic state, which may be identified, controlled and stabilized with small control force inputs. With the aid of the aforementioned attractor reconstruction from a suitable time series, it is possible to determine the unstable states having a regular dynamic as unstable fixed points of the system considered. In this way, all unstable states having a regular dynamic are maintained. From this, it is now possible to select a non-stable, non-dendritic state suitable for the specific use, for example, for a lithium-ion rechargeable battery. This occurs, in particular, as a result of the focus on homogeneous pattern formation states, which are non-dendritic. Such states are preferably determined based on the aforementioned attractor reconstruction from a suitable time series.

The magnetic or electric field generates a control force, which is adjusted in such a way that the unstable state having a regular dynamic identified as suitable may be stabilized. If dendritic metal deposition in a lithium-ion rechargeable battery is to be reduced, then a suitably modulated magnetic or electric field may be formed, both from within as well as from outside the rechargeable battery.

A lithium-ion rechargeable battery according to the present invention includes an anode having an anode arrester, a cathode having a cathode arrester, and a separator, which are situated in a housing, a dendritic metal deposition at the anode being reduced with the aid of the method according to the present invention.

In one specific embodiment of the present invention, it is preferred that the housing is situated in a solenoid, the solenoid being configured to be passed through by a time-variable electric current, in such a way that it generates a magnetic field, which is modulated in such a way that it stabilizes the non-dendritic state of the metal deposition at the anode. In this way a control force is formed from outside the lithium-ion rechargeable battery. Only minimal current intensities are required since, according to the present invention, only a weak magnetic field becomes necessary. Thus, the solenoid may be supplied with electrical energy, particularly preferably by the lithium-ion rechargeable battery.

In another preferred specific embodiment of the present invention, the housing of the lithium-ion rechargeable battery is coated with a magnetizable material, which is permanently magnetized in such a way that a magnetic field is generated, which is modulated in such a way that it stabilizes the non-dendritic state of the metal deposition at the anode. The magnetization step may take place either on the rechargeable battery housing modified according to the present invention prior to installation, or in the rechargeable battery after installation. This specific embodiment of the lithium-ion rechargeable battery according to the present invention is suitable, in particular, for lithium-ion batteries in the form of rechargeable battery windings or rechargeable battery stacks.

In still another preferred specific embodiment of the present invention, a magnetizable material is situated in the housing, and is permanently magnetized in such a way that it generates a magnetic field, which is modulated in such a way that it stabilizes the metal deposition at the anode in the non-dendritic state. It is particularly preferred that the magnetizable material is introduced into the separator in the form of particles. Just as it is known to introduce ceramic particles into separators, the separator for this purpose is populated with magnetizable material particles. These may, in particular, be woven into the separator material. Subsequently, the desired magnetic field may be imprinted by an external magnetic field onto the correspondingly prepared separator. If the separator is then installed in the lithium-ion rechargeable battery, it is able according to the present invention to stabilize the dendrite-free metal deposition. For this purpose, the magnetic fields generated according to the present invention are, in particular, weak and therefore act locally at the site of the metal deposition. The magnetization step may occur prior to installation or after installation of the separator in the lithium-ion rechargeable battery. Alternatively, it is particularly preferred that the separator has a coating made of a magnetizable material on its side facing the anode. It is also particularly preferred that the anode has a coating made of a magnetizable material. In this case, it is more particularly preferred in one specific embodiment of the present invention that the magnetizable material is applied as a coating on the side of the anode facing the separator. In another specific embodiment of the present invention, it is more particularly preferred that the magnetizable material is applied as a coating between the anode and the anode arrester.

The magnetizable material is preferably selected from the group including Fe₃O₄, SmCo₅, Sm₂Co₁₇, Fe₁₄Nd₂B, BaO.6Fe₂O₃, Co₂₄Ni₁₄Al₈Fe, Fe₄₆Cr₃₁Co₂₃, and mixtures thereof.

In the method for manufacturing a lithium-ion rechargeable battery according to the present invention, a non-dendritic state of the metal deposition is ascertained at the anode of the lithium-ion rechargeable battery, and a means for generating a magnetic or electric field is situated on or in the lithium-ion rechargeable battery. The field in this case is modulated in such a way that it stabilizes the non-dendritic state of the metal deposition at the anode. It is preferred that the means is a magnetizable material, which is permanently magnetized prior to or after its arrangement on or in the lithium-ion rechargeable battery.

### BRIEF DESCRIPTION OF THE DRAWINGS

FIG. 1 shows a cross sectional representation of a lithium-ion rechargeable battery according to the related art.

FIG. 2 shows an isometric representation of a lithium-ion rechargeable battery according to one specific embodiment of the present invention.

FIG. 3 shows a cross sectional representation of a lithium-ion rechargeable battery according to another specific embodiment of the present invention.

FIG. 4 shows a cross sectional representation of a lithium-ion rechargeable battery according to still another specific embodiment of the present invention.

FIG. 5 shows a cross sectional representation of a lithium-ion rechargeable battery according to still another specific embodiment of the present invention.

### DETAILED DESCRIPTION OF THE INVENTION

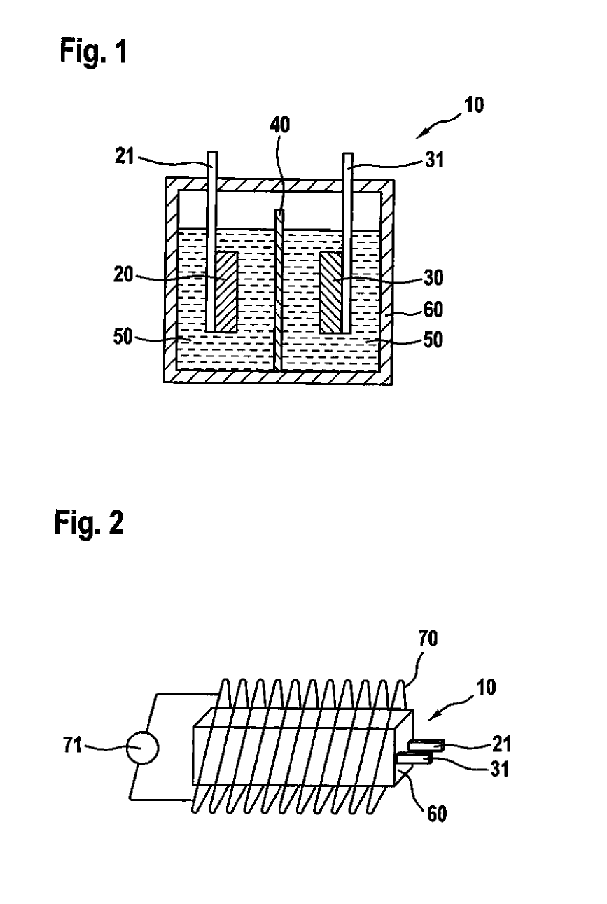

FIG. 1 shows a schematic cross sectional representation of a conventional lithium-ion rechargeable battery 10. An anode 20, which includes active anode material, is situated on an anode arrester 21. A cathode 30, which includes active cathode material, is situated on a cathode arrester 31. A separator 40 prevents interior short circuits from occurring between electrodes 20, 30, by isolating two electrodes 20, 30 spatially and electrically from one another. Situated between two electrodes 20, 30 is a liquid electrolyte 50. The latter typically includes a solvent and a lithium-containing salt. Two electrodes 20, 30, separator 40 and electrolyte 50 are situated together in a housing 60. Both anode arrester 21 and cathode arrester 31 penetrate housing 60, and thus enable the electrical contacting of anode 20 and cathode 30. If this lithium-ion rechargeable battery 10 is operated using non-classic electrode materials, for example, as a lithium-sulfur rechargeable battery or a lithium-air rechargeable battery, the result is heavy dendritic growth of lithium metal on anode 20.

According to the present invention, a non-dendritic state of the metal deposition on the electrode is first ascertained with the aid of a method of non-linear pattern formation analysis on a conventional lithium-ion rechargeable battery 10 according to FIG. 1, and it is determined how a magnetic field must be generated and modulated, so that it stabilizes the non-dendritic state of the metal deposition. For this purpose, a method of chaos control is applied, as it is described in Phys. Rev. Lett. 89, 074101 (2002), N. Baba et al. This document is incorporated fully by reference into this patent application. If it is known how the magnetic field must be generated and modulated, it is then possible to manufacture various specific embodiments of lithium-ion accumulators 10 according to the present invention, in which a dendritic metal deposition on anode 20 is suppressed or strongly inhibited.

An analysis method of the non-linear pattern formation in this case includes the transitioning of a metal deposition on the electrode into a chaotic state, ascertaining unstable states of the metal deposition having a regular dynamic with the aid of an attractor reconstruction from an experimental time series of the system considered, and selecting from the unstable states a homogeneous state as a non-dendritic or a suitable dendritically reduced state.

For this, the position of the targeted orbit and the linearized equations of motion in its vicinity are needed. The latter may be obtained with the aid of the attractor reconstruction from an experimental time series. Since in this case the formula for a parameter change dm is based on a linearization, a two-dimensional iterated derivation zₜ₊₁ (m+dm) is in general not exactly a stable manifold W⁶(m), so that in every additional iteration t, small parameter changes δ μₜ become necessary. For the same reason, the control procedure is employed only if a chaotic trajectory z* (m) assumes a certain minimum distance from the stable manifold. The latter occurs continually due to the ergodic behavior (ergodic theory) on an attractor or in an ergodic component of the system. The orbit of the system with control employed is an example of a chaotic transient. The generalization of the procedure described to higher-dimensional or time-continuous systems is based on known methods of control theory.

An alternative method for stabilizing unstable periodic orbits in chaotic systems uses a time-delayed feedback of the system state to the system parameters. In a time-continuous system, for example, x=f(x(t),t), the right side in this case is replaced by F(x(t), K[x(t)−x(t−r)],t) with a time delay t, wherein F(x(t),0,t)=f(x(t),t) must apply.

In a first specific embodiment of the present invention, the lithium-ion rechargeable battery according to FIG. 1 has for this purpose a coating made of a magnetizable material on its housing 60, which is permanently magnetized in such a way that it generates a magnetic field, which is modulated in such a way that it stabilizes the non-dendritic state of the metal deposition of anode 20.

A second specific embodiment of a lithium-ion rechargeable battery is depicted in FIG. 2. A solenoid 70 connected to an external energy source 71 is wound around housing 60 of lithium-ion rechargeable battery 10. With the aid of solenoid 70, it is possible to generate a time-variable magnetic field, which is modulated in such a way that it stabilizes the non-dendritic state of the metal deposition of the anode. The lithium-ion rechargeable battery 10 may itself also function as an energy source for solenoid 70 via anode arrester 21 and cathode arrester 31, and thus replace external energy source 71.

In a third specific embodiment of the lithium-ion rechargeable battery according to the present invention, magnetizable particles are woven into separator 40 of lithium-ion rechargeable battery 10 according to FIG. 1. These particles are permanently magnetized through application of an external magnetic field, in such a way that they generate a magnetic field, which is modulated in such a way that it stabilizes the non-dendritic state of the metal deposition at anode 20.

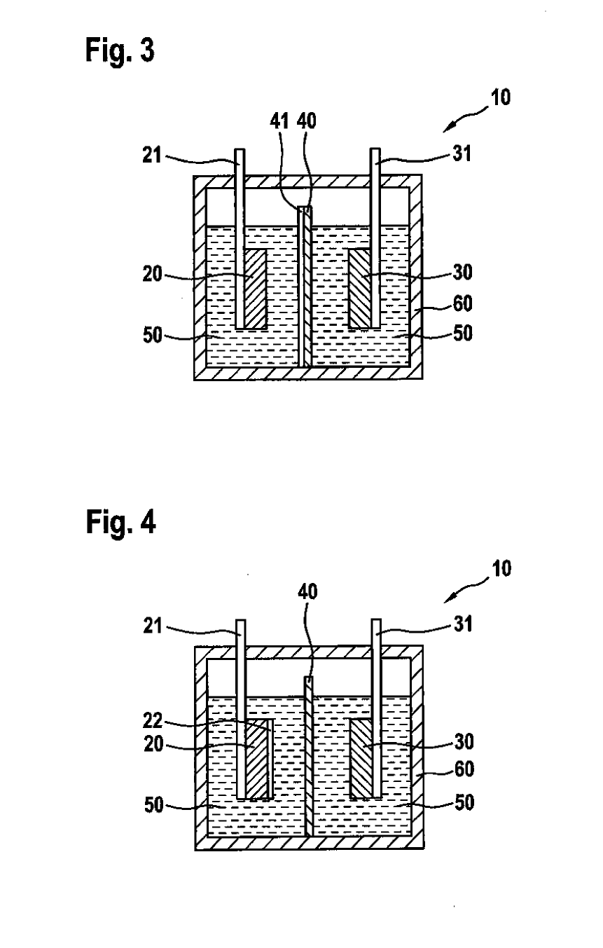

FIG. 3 shows a lithium-ion rechargeable battery 10 according to a fourth specific embodiment of the present invention. Separator 40 has a coating 41 made of magnetizable material on its side facing anode 20. This coating 41 is permanently magnetized through application of an external magnetic field, in such a way that it generates a magnetic field, which is modulated in such a way that it stabilizes the non-dendritic state of the metal deposition at anode 20.

A fifth specific embodiment of the lithium-ion rechargeable battery according to the present invention is depicted in FIG. 4. Anode 20 has a coating 22 made of a magnetizable material on its side facing separator 40. This coating 22 is permanently magnetized through application of an external magnetic field, in such a way that it generates a magnetic field, which is modulated in such a way that it stabilizes the non-dendritic state or the dendritically reduced state of the metal deposition on anode 20 or, in the present case, on coating 22.

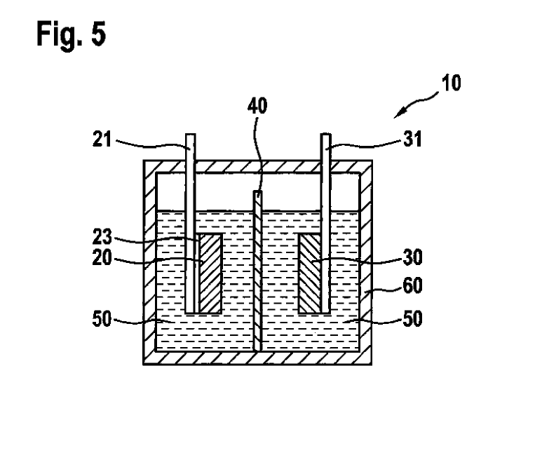

FIG. 5 shows a lithium-ion rechargeable battery according to a sixth specific embodiment of the present invention. A layer 23 made of a magnetizable material is situated between anode 20 and anode arrester 21. This layer is permanently magnetized through application of an external magnetic field, in such a way that it generates a magnetic field, which stabilizes the non-dendritic state of the metal deposition at anode 20.

The magnetizable material in the second through the sixth specific embodiments of the lithium-ion rechargeable battery 10 according to the present invention may be selectively permanently magnetized prior to or after assembly of all components of the lithium-ion rechargeable battery 10.

What is claimed is:

1. A method for reducing the dendritic metal deposition on an electrode, comprising:
ascertaining a non-dendritic state of the metal deposition at the electrode;
generating one of a magnetic or electric field at the electrode; and
modulating the one of the magnetic or electric field to stabilize the non-dendritic state of the metal deposition.

2. The method as recited in claim 1, wherein the non-dendritic state of the metal deposition is ascertained by an analysis method of the non-linear pattern formation.

3. The method as recited in claim 2, wherein the analysis method of the non-linear pattern formation includes:
transitioning a metal deposition on the electrode into a chaotic state;
ascertaining unstable states of the metal deposition having a regular dynamic with the aid of an attractor reconstruction from an experimental time series of the system considered; and
selecting a state from the unstable states as one of the non-dendritic state or a dendritically reduced state.

4. A lithium-ion rechargeable battery, comprising:
an anode having an anode arrester;
a cathode having a cathode arrester;
a separator; and
a housing containing the anode, the cathode and the separator;
wherein a dendritic metal deposition at the anode is reduced by:
ascertaining a non-dendritic state of the metal deposition at the electrode;
generating one of a magnetic or electric field at the electrode; and
modulating the one of the magnetic or electric field to stabilize the non-dendritic state of the metal deposition.

5. The lithium-ion rechargeable battery as recited in claim 4, wherein the housing is situated in a solenoid configured to be passed through by a time-variable electric current to generate a magnetic field, and wherein the magnetic field is modulated to stabilize the non-dendritic state of the metal deposition at the anode.

6. The lithium-ion rechargeable battery as recited in claim 5, wherein the solenoid is supplied with electrical energy by the lithium-ion rechargeable battery.

7. The lithium-ion rechargeable battery as recited in claim 4, wherein the housing is coated with a material which is permanently magnetized to generate a magnetic field, and wherein the magnetic field is modulated to stabilize the non-dendritic state of the metal deposition at the anode.

8. The lithium-ion rechargeable battery as recited in claim 4, wherein a permanently magnetized material is situated in the housing to generate a magnetic field, and wherein the magnetic field is modulated to stabilize the non-dendritic state of the metal deposition at the anode.

9. The lithium-ion rechargeable battery as recited in claim 8, wherein the permanently magnetized material includes one of (i) a magnetizable material introduced into the separator in the form of particles, or (ii) a coating made of the magnetizable material on a side of the separator facing the anode.

10. The lithium-ion rechargeable battery as recited in claim 8, wherein the permanently magnetized material includes one of (i) a coating applied on the side of the anode facing the separator, or (ii) a coating applied between the anode and the anode arrester.

11. A method for manufacturing a lithium-ion rechargeable battery, comprising:
ascertaining a non-dendritic state of a metal deposition at an anode; and
generating one of a magnetic field or electric field by a field generating element situated one of on or in the lithium-ion rechargeable battery; and
modulating the one of the magnetic field or the electric field to stabilize the non-dendritic state of the metal deposition at the anode.

12. The method for manufacturing a lithium-ion rechargeable battery as recited in claim 11, wherein the field generating element is a magnetizable material which is permanently magnetized and situated one of on or in the lithium-ion rechargeable battery.
